(19) United States
(12) Patent Application Publication
(10) Pub. No.: US 2012/0234278 A1
(43) Pub. Date: Sep. 20, 2012

(54) Diesel Fuel Compositions

(76) Inventors: David Hugh Lloyd, Chester (GB); Treyor Stephenson, Chester (GB)

(21) Appl. No.: 13/480,783

(22) Filed: May 25, 2012

Related U.S. Application Data
(63) Continuation of application No. 10/738,078, filed on Dec. 17, 2003, now abandoned.

(30) Foreign Application Priority Data
Dec. 20, 2002 (EP) 02258908.9

(51) Int. Cl. F02B 43/12

(52) U.S. Cl. 123/1 A

(57) ABSTRACT

The use of a Fischer-Tropsch derived fuel in a fuel composition that improves the responsiveness of a compression ignition engine, such as a turbocharged direct injection diesel engine, and/or a vehicle which is powered by such engine, is provided. A method of improving the responsiveness of such an engine and/or vehicle powered by such an engine by replacing in such engine a fuel composition which contains no Fischer-Tropsch derived fuel by a Fischer-Tropsch derived fuel or a fuel composition which contains a Fischer-Tropsch derived fuel is also provided.

### FIELD OF THE INVENTION

The present invention relates to a method of operating compression ignition engines using certain types of diesel fuel compositions.

### BACKGROUND OF THE INVENTION

In a performance vehicle, particularly in a vehicle driven by a turbocharged direct injection diesel engine, the consumers desire improvements in the responsiveness of the engine.

### SUMMARY OF THE INVENTION

In one embodiment, a method of improving the responsiveness of a compression ignition engine and/or a vehicle powered by such an engine is provided by replacing in said engine a fuel composition which contains no Fischer-Tropsch derived fuel by a Fischer-Tropsch derived fuel or a fuel composition which contains a Fischer-Tropsch derived fuel.

In another embodiment, a method of operating a compression ignition engine and/or a vehicle which is powered by such an engine is provided comprising introducing into a combustion chamber of the engine a Fischer-Tropsch derived fuel or a fuel composition containing a Fischer-Tropsch derived fuel, thereby improving the responsiveness of said engine and/or said vehicle compared to a fuel composition which contains no Fischer-Tropsch derived fuel.

### BRIEF DESCRIPTION OF THE DRAWINGS

Advantages of the present invention will become apparent to those skilled in the art with the benefit of the following detailed description of embodiments and upon reference to the accompanying drawings in which:

FIG. 1 is a plot of acceleration times when using conventional diesel fuels F1 and F2 and Fischer-Tropsch blends B1, B2, and B3, as described in Example 1 below.

### DETAILED DESCRIPTION OF THE INVENTION

It has been found that Fischer-Tropsch derived fuels can contribute to an improvement in the responsiveness of a compression ignition engine and/or a vehicle which is powered by such an engine. A fuel composition containing such components can therefore be used to help improve the performance, particularly the acceleration, of such an engine or vehicle.

In accordance with one embodiment of the present invention there is provided the use of a Fischer-Tropsch derived fuel in a fuel composition, for the purpose of improving the responsiveness of a compression ignition engine and/or a vehicle powered by such an engine, into which engine the fuel composition is introduced.

In this specification, “improving the responsiveness” means as compared to the responsiveness of an engine and/or a vehicle wherein the fuel composition used contains no Fischer-Tropsch derived fuel.

In another embodiment of the present invention there is also provided the use of a Fischer-Tropsch derived fuel, or of a fuel composition containing a Fischer-Tropsch derived fuel, to improve the responsiveness of a compression ignition engine and/or a vehicle powered by such an engine, into which engine said fuel or fuel composition is introduced.

In said uses according to the present invention, said compression ignition engine is preferably a turbocharged direct injection diesel engine.

In one embodiment of the present invention there is still further provided a method of improving the responsiveness of a compression ignition engine and/or a vehicle powered by such an engine by replacing in said engine a fuel composition which contains no Fischer-Tropsch derived fuel by a Fischer-Tropsch derived fuel or a fuel composition which contains a Fischer-Tropsch derived fuel.

In another embodiment of the present invention there is yet further provided a method of operating a compression ignition engine and/or a vehicle which is powered by such an engine, which method involves introducing into a combustion chamber of the engine a Fischer-Tropsch derived fuel or a fuel composition containing a Fischer-Tropsch derived fuel, for the purpose of improving the responsiveness of said engine and/or said vehicle.

In said methods according to the present invention, said compression ignition engine is preferably a turbocharged direct injection diesel engine.

The Fischer-Tropsch derived fuel should be suitable for use as a diesel fuel. Its components (or the majority, for instance 95% w/w or greater, thereof) should therefore have boiling points within the typical diesel fuel (“gas oil”) range, i.e. from 150 to 400° C. or from 150 to 370° C. It will suitably have a 90% v/v distillation temperature (T90) of from 300 to 370° C.

By “Fischer-Tropsch derived” is meant that the fuel is, or derives from (produced from), a synthesis product of a Fischer-Tropsch condensation process. The Fischer-Tropsch reaction converts carbon monoxide and hydrogen into longer chain, usually paraffinic, hydrocarbons:

n(CO+2H₂)=(—CH₂—)ₙ+nH₂O+heat,

in the presence of an appropriate catalyst and typically at elevated temperatures (e.g. 125 to 300° C., preferably 175 to 250° C.) and/or pressures (e.g. 500 to 10000 kPa, preferably 1200 to 5000 kPa). Hydrogen:carbon monoxide ratios other than 2:1 may be employed if desired.

The carbon monoxide and hydrogen may themselves be derived from organic or inorganic, natural or synthetic sources, typically either from natural gas or from organically derived methane.

A gas oil product may be obtained directly from this reaction, or indirectly for instance by fractionation of a Fischer-Tropsch synthesis product or from a hydrotreated Fischer-Tropsch synthesis product. Hydrotreatment can involve hydrocracking to adjust the boiling range (see, e.g. GB-B-2077289 and EP-A-0147873) and/or hydroisomerisation which can improve cold flow properties by increasing the proportion of branched paraffins. EP-A-0583836 describes a two-step hydrotreatment process in which a Fischer-Tropsch synthesis product is firstly subjected to hydroconversion under conditions such that it undergoes substantially no isomerisation or hydrocracking (this hydrogenates the olefinic and oxygen-containing components), and then at least part of the resultant product is hydroconverted under conditions such that hydrocracking and isomerisation occur to yield a substantially paraffinic hydrocarbon fuel. The desired gas oil fraction(s) may subsequently be isolated for instance by distillation.

Other post-synthesis treatments, such as polymerisation, alkylation, distillation, cracking-decarboxylation, isomerisation and hydroreforming, may be employed to modify the properties of Fischer-Tropsch condensation products, as described for example in U.S. Pat. No. 4,125,566 and U.S. Pat. No. 4,478,955.

Typical catalysts for the Fischer-Tropsch synthesis of paraffinic hydrocarbons comprise, as the catalytically active component, a metal from Group VIII of the periodic table, in particular ruthenium, iron, cobalt or nickel. Suitable such catalysts are described for example in EP-A-0583836 (pages 3 and 4).

An example of a Fischer-Tropsch based process is the SMDS (Shell Middle Distillate Synthesis) described in “The Shell Middle Distillate Synthesis Process”, van der Burgt et al (paper delivered at the 5^{th} Synfuels Worldwide Symposium, Washington D.C., November 1985; see also the November 1989 publication of the same title from Shell International Petroleum Company Ltd., London, UK). This process (also sometimes referred to as the Shell™ “Gas-to-Liquids” or “GTL” technology) produces middle distillate range products by conversion of a natural gas (primarily methane) derived synthesis gas into a heavy long-chain hydrocarbon (paraffin) wax which can then be hydroconverted and fractionated to produce liquid transport fuels such as the gas oils useable in diesel fuel compositions. A version of the SMDS process, utilizing a fixed-bed reactor for the catalytic conversion step, is currently in use in Bintulu, Malaysia and its products have been blended with petroleum derived gas oils in commercially available automotive fuels.

Gas oils prepared by the SMDS process are commercially available from the Royal Dutch/Shell Group of Companies. Further examples of Fischer-Tropsch derived gas oils are described in EP-A-0583836, EP-A-1101813, WO-A-97/14768, WO-A-97/14769, WO-A-00/20534, WO-A-00/20535, WO-A-01/11116, WO-A-01/11117, WO-A-01/83406, WO-A-01/83641, WO-A-01/83647, WO-A-01/83648 and U.S. Pat. No. 6,204,426.

Suitably, in accordance with the present invention, the Fischer-Tropsch derived gas oil will consist of at least 70% w/w, preferably at least 80% w/w, more preferably at least 90% w/w, most preferably at least 95% w/w, of paraffinic components, preferably iso- and linear paraffins. The weight ratio of iso-paraffins to normal paraffins will suitably be greater than 0.3 and may be up to 12; suitably it is from 2 to 6. The actual value for this ratio will be determined, in part, by the hydroconversion process used to prepare the gas oil from the Fischer-Tropsch synthesis product. Some cyclic paraffins may also be present.

By virtue of the Fischer-Tropsch process, a Fischer-Tropsch derived gas oil has essentially no, or undetectable levels of, sulphur and nitrogen. Compounds containing these heteroatoms tend to act as poisons for Fischer-Tropsch catalysts and are therefore removed from the synthesis gas feed. Further, the process as usually operated produces no or virtually no aromatic components. The aromatics content of a Fischer-Tropsch gas oil, as determined by ASTM D4629, will typically be below 1% w/w, preferably below 0.5% w/w and more preferably below 0.1% w/w.

The Fischer-Tropsch derived gas oil used in the present invention will typically have a density from 0.76 to 0.79 g/cm³ at 15° C.; a cetane number (ASTM D613) greater than 70, suitably from 74 to 85; a kinematic viscosity from 2.0 to 4.5, preferably from 2.5 to 4.0, more preferably from 2.9 to 3.7, mm²/s at 40° C.; and a sulphur content of 5 ppmw (parts per million by weight) or less, preferably of 2 ppmw or less.

Preferably it is a product prepared by a Fischer-Tropsch methane condensation reaction using a hydrogen/carbon monoxide ratio of less than 2.5, preferably less than 1.75, more preferably from 0.4 to 1.5, and ideally using a cobalt containing catalyst. Suitably it will have been obtained from a hydrocracked Fischer-Tropsch synthesis product (for instance as described in GB-B-2077289 and/or EP-A-0147873), or more preferably a product from a two-stage hydroconversion process such as that described in EP-A-0583836 (see above). In the latter case, preferred features of the hydroconversion process may be as disclosed at pages 4 to 6, and in the examples, of EP-A-0583836.

The present invention is particularly applicable where the fuel composition is used or intended to be used in a direct injection diesel engine, for example of the rotary pump, in-line pump, unit pump, electronic unit injector or common rail type, or in an indirect injection diesel engine. It may be of particular value for rotary pump engines, and in other diesel engines which rely on mechanical actuation of the fuel injectors and/or a low pressure pilot injection system. The fuel composition may be suitable for use in heavy and/or light duty diesel engines.

The amount of Fischer-Tropsch derived gas oil used may be from 0.5 to 100% v/v of the overall diesel fuel composition, preferably from 0.5 to 75% v/v. It is particularly preferred for the composition to contain 1 to 50% v/v, and particularly 1 to 25% v/v, of the Fischer-Tropsch derived gas oil. The balance of the fuel composition is made up of one or more other fuels.

The SMDS reaction products suitably have boiling points within the typical diesel fuel range (between 150 and 370° C.), a density of between 0.76 and 0.79 g/cm at 15° C., a cetane number greater than 72.7 (typically between 75 and 82), a sulphur content of less than 5 ppmw, a viscosity between 2.9 and 3.7 mm²/s at 40° C. and an aromatics content of no greater than 1% w/w.

The fuel composition of the present invention may, if required, contain one or more additives as described below.

Detergent-containing diesel fuel additives are known and commercially available, for instance from Infineum (e.g. F7661 and F7685) and Octel (e.g. OMA 4130D). Such additives may be added to diesel fuels at relatively low levels (their “standard” treat rates providing typically less than 100 ppmw active matter detergent in the overall additivated fuel composition) intended merely to reduce or slow the build up of engine deposits.

Examples of detergents suitable for use in fuel additives for the present purpose include polyolefin substituted succinimides or succinamides of polyamines, for instance polyisobutylene succinimides or polyisobutylene amine succinamides, aliphatic amines, Mannich bases or amines and polyolefin (e.g. polyisobutylene) maleic anhydrides. Succinimide dispersant additives are described for example in GB-A-960493, EP-A-0147240, EP-A-0482253, EP-A-0613938, EP-A-0557561 and WO-A-98/42808. Particularly preferred are polyolefin substituted succinimides such as polyisobutylene succinimides.

The additive may contain other components in addition to the detergent. Examples are lubricity enhancers; dehazers, e.g. alkoxylated phenol formaldehyde polymers such as those commercially available as NALCO™ EC5462A (formerly 7D07) (ex Nalco) and TOLAD™ 2683 (ex Petrolite); anti-foaming agents (e.g. the polyether-modified polysiloxanes commercially available as TEGOPREN™ 5851 and Q 25907 (ex Dow Corning), SAG™ TP-325 (ex OSi) and RHODORSIL™ (ex Rhone Poulenc)); ignition improvers (cetane improvers) (e.g. 2-ethylhexyl nitrate (EHN), cyclohexyl nitrate, di-tert-butyl peroxide and those disclosed in U.S. Pat. No. 4,208,190 at column 2, line 27 to column 3, line 21); anti-rust agents (e.g. that sold commercially by Rhein Chemie, Mannheim, Germany as “RC 4801”, a propane-1,2-diol semi-ester of tetrapropenyl succinic acid, or polyhydric alcohol esters of a succinic acid derivative, the succinic acid derivative having on at least one of its alpha-carbon atoms an unsubstituted or substituted aliphatic hydrocarbon group containing from 20 to 500 carbon atoms, e.g. the pentaerythritol diester of polyisobutylene-substituted succinic acid); corrosion inhibitors; reodorants; anti-wear additives; anti-oxidants (e.g. phenolics such as 2,6-di-tert-butylphenol, or phenylenediamines such as N,N′-di-sec-butyl-p-phenylenediamine); and metal deactivators.

It is particularly preferred that the additive include a lubricity enhancer, especially when the fuel composition has a low (e.g. 500 ppmw or less) sulphur content. In the additivated fuel composition, the lubricity enhancer is conveniently present at a concentration between 50 and 1000 ppmw, preferably between 100 and 1000 ppmw. Suitable commercially available lubricity enhancers include EC 832 and PARADYNE™ 655 (ex Infineum), HITEC™ E580 (ex Ethyl Corporation), VEKTRON™ 6010 (ex Infineum) and amide-based additives such as those available from the Lubrizol Chemical Company, for instance LZ 539 C. Other lubricity enhancers are described in the patent literature, in particular in connection with their use in low sulfur content diesel fuels, for example in:
the paper by Danping Wei and H. A. Spikes, “The Lubricity of Diesel Fuels”, Wear, III (1986) 217-235;
WO-A-95/33805—cold flow improvers to enhance lubricity of low sulfur fuels;
WO-A-94/17160—certain esters of a carboxylic acid and an alcohol wherein the acid has from 2 to 50 carbon atoms and the alcohol has 1 or more carbon atoms, particularly glycerol monooleate and di-isodecyl adipate, as fuel additives for wear reduction in a diesel engine injection system;
U.S. Pat. No. 5,484,462—mentions dimerised linoleic acid as a commercially available lubricity agent for low sulfur diesel fuel (column 1, line 38), and itself provides aminoalkylmorpholines as fuel lubricity improvers;
U.S. Pat. No. 5,490,864—certain dithiophosphoric diester-dialcohols as anti-wear lubricity additives for low sulfur diesel fuels; and
WO-A-98/01516—certain alkyl aromatic compounds having at least one carboxyl group attached to their aromatic nuclei, to confer anti-wear lubricity effects particularly in low sulfur diesel fuels.

It is also preferred that the additive contain an anti-foaming agent, more preferably in combination with an anti-rust agent and/or a corrosion inhibitor and/or a lubricity additive.

Unless otherwise stated, the (active matter) concentration of each such additional component in the additivated fuel composition is preferably up to 10000 ppmw, more preferably in the range from 5 to 1000 ppmw, advantageously from 75 to 300 ppmw, such as from 95 to 150 ppmw.

The (active matter) concentration of any dehazer in the fuel composition will preferably be in the range from 1 to 20 ppmw, more preferably from 1 to 15 ppmw, still more preferably from 1 to 10 ppmw, advantageously from 1 to 5 ppmw. The (active matter) concentration of any ignition improver present will preferably be 600 ppmw or less, more preferably 500 ppmw or less, conveniently from 300 to 500 ppmw.

The additive will typically contain the detergent, optionally together with other components as described above, and a diesel fuel-compatible diluent, which may be a carrier oil (e.g. a mineral oil), a polyether, which may be capped or uncapped, a non-polar solvent such as toluene, xylene, white spirits and those sold by member companies of the Royal Dutch/Shell Group under the trade mark “SHELLSOL”, and/or a polar solvent such as an ester and, in particular, an alcohol, e.g. hexanol, 2-ethylhexanol, decanol, isotridecanol and alcohol mixtures such as those sold by member companies of the Royal Dutch/Shell Group under the trade mark “LINEVOL”, especially LINEVOL™ 79 alcohol which is a mixture of C₇₋₉ primary alcohols, or the C₁₂₋₁₄ alcohol mixture commercially available from Sidobre Sinnova, France under the trade mark “SIPOL”.

The additive may be suitable for use in heavy and/or light duty diesel engines.

The Fischer-Tropsch fuel may be used in combination with any other fuel suitable for use in a diesel engine, such as a conventional base fuel. Vegetable oils may also be used in mixture with the Fischer-Tropsch derived fuel, either per se or in blends with other hydrocarbon fuels.

Such a conventional base fuel may typically comprise liquid hydrocarbon middle distillate fuel oil(s), for instance petroleum derived gas oils. Such fuels will typically have boiling points with the usual diesel range of 150 to 400° C., depending on grade and use. It will typically have a density from 0.75 to 0.9 g/cm³, preferably from 0.8 to 0.86 g/cm³, at 15° C. (e.g. ASTM D4502 or IP 365) and a cetane number (ASTM D613) of from 35 to 80, more preferably from 40 to 75. It will typically have an initial boiling point in the range 150 to 230° C. and a final boiling point in the range 290 to 400° C. Its kinematic viscosity at 40° C. (ADTM D445) might suitably be from 1.5 to 4.5 mm²/s.

The fuel may itself be additivated (additive-containing) or unadditivated (additive-free). If additivated, e.g. at the refinery, it will contain minor amounts of one or more additives selected for example from anti-static agents, pipeline drag reducers, flow improvers (e.g. ethylene/vinyl acetate copolymers or acrylate/maleic anhydride copolymers) and wax anti-settling agents (e.g. those commercially available under the Trade Marks “PARAFLOW” (e.g. PARAFLOW™ 450, ex Infineum), “OCTEL” (e.g. OCTEL™ W 5000, ex Octel) and “DODIFLOW” (e.g. DODIFLOW™ v 3958, ex Hoechst).

### EXAMPLES

The present invention will now be described by way of example, by reference to the accompanying drawing, in which:

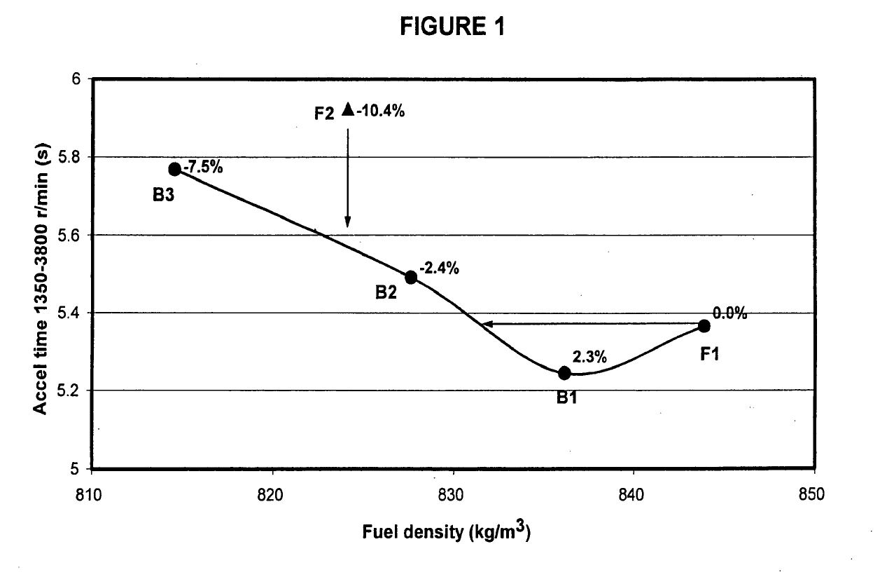

FIG. 1 shows acceleration times when using conventional diesel fuels F1 and F2 and Fischer-Tropsch blends B1, B2, and B3, as described in Example 1 below.

### Example 1

This example illustrates the effects on the responsiveness of a first engine using Fischer-Tropsch derived diesel fuel.

### Test Fuels

The fuels used in the tests were petroleum derived diesel fuels F1 and F2, and blends containing varying proportions of petroleum derived diesel fuel F1 and a Fischer-Tropsch (SMDS) derived diesel fuel F3. The properties of fuels F1, F2 and F3 are shown in Table 1:

TABLE 1

| Fuel property | F1 | F2 | F3 |
|---|---|---|---|
| Density @ 15° C. | 844.4 | 824.1 | 785.2 |
| (IP365/ASTM D4502), | | | |
| kg/cm³ | | | |

Distillation (IP23/ASTM D86)

| | | | |
|---|---|---|---|
| Initial boiling point, ° C. | 183.1 | 176.0 | 211.5 |
| T50, ° C. | 280 | 250.0 | 298 |
| T90, ° C. | 333.8 | 330.0 | 339 |
| Final boiling point, ° C. | 373.3 | 357.0 | 354.5 |
| Cetane number | nm | 52.9 | >74.8 |
| (ASTM D613) | | | |
| Cetane index | 51.3 | 52.1 | 77.2 |
| (IP364/84/ASTM D976) | | | |
| Kinematic viscosity @ | nm | 2.266 | 3.606 |
| 40° C. (IP71/ASTMD445), mm²/s | | | |
| Sulfur (ASTM D2622), | 350 | 101 | <5 |
| mg/kg | | | |
| Aromatic content | 23.8 | 19.2 | 0.1 |
| (IP391 Mod), % m | | | |
| Flash point, ° C. | >55 | >55 | 91 |

nm = not measured

Fuel F3 had been obtained from a Fischer-Tropsch (SMDS) synthesis product via a two-stage hydroconversion process analogous to that described in EP-A-0583836.

### Test Engine

The engine used in the tests described below was a turbocharged Audi 2.5 L direct injection diesel engine. However, it is emphasized that any suitable engine could be used to demonstrate the advantages of the present invention.

The test engine had the specification set out in Table 2:

TABLE 2

| | |
|---|---|
| Type | Audi 2.5 TDI AAT Compression Ignition |
| Number of cylinders | 5 |
| Swept volume | 2460 cm³ |
| Bore | 81.0 mm |
| Stroke | 95.5 mm |
| Number of cylinders | 5 |
| Nominal compression ratio | 21.0:1 |
| Maximum charge pressure | 1.65 bar (1650 kPa) @ 4000 rpm |
| Maximum power (boosted) | 115 brake horsepower (85.8 |
| | kilowatts) @ 4000 rpm (DIN) |
| Maximum torque (boosted) | 265 Nm (DIN) @ 2250 rpm |

Its fuel injection equipment (Bosch™) had the following specification:
Nozzle and injector assembly: Bosch 0 432 193 786
Nozzle opening pressure: 190 to 200 bar (19 to 20 MPa), single stage
Injection pump: Bosch VEL 400 Part No. 0 460 415 998

No modifications of the fuel injection system were made on installation on to a bench stand. The fuel injection system is essentially identical to that on the road vehicle.

### Test Blends

In the following tests, blends B1, B2 and B3 containing respectively 15% v/v, 30% v/v and 50% v/v of Fischer-Tropsch derived (SMDS) diesel fuel F3 in admixture with fuel F2, were compared with fuels F1 and F2.

Details of blends B1, B2 and B3 are shown in Table 3:

TABLE 3

| Fuel property | B1 | B2 | B3 |
|---|---|---|---|
| Density @ 15° C. | 836.1 | 827.0 | 814.7 |
| (IP365/ASTM D4502), | | | |
| kg/cm³ | | | |
| Initial boiling point, | 187 | 191 | 197 |
| ° C. | | | |
| T50, ° C. | 283 | 285 | 289 |
| T90, ° C. | 334 | 335 | 336 |
| Final boiling point, | 370 | 367 | 364 |
| ° C. | | | |
| Cetane index | 55.2 | 59.1 | 64.5 |
| (IP364/84/ASTM D976) | | | |
| Sulfur (ASTM D2622), | 251.0 | 251.0 | 107.6 |
| mg/kg | | | |
| Aromatic content | 16.7 | 16.7 | 7.2 |
| (IP391 Mod), % m | | | |
| Flash point, ° C. | >55 | >55 | >55 |

Blends B1, B2 and B3 were prepared in 200 L drums by splash blending, i.e. the component in the smaller quantity is introduced first and this is then topped up with the component in the larger quantity to ensure good mixing.

### Test Procedure

The engine referred to above was used in a bench engine format.

Responsiveness relates to the response of an engine to changes in throttle position (i.e. drive demand) and the use of a bench engine brings the throttle under direct computer control. The responsiveness of a compression ignition engine may be established by measuring acceleration times.

On the test bench, the coolant, oil and inter-cooler temperatures were held constant so that all tests would be conducted under identical conditions. The engine was fully warmed up before measurements began.

Data were recorded from the test bench at 32 Hz in order to capture the details of the transient response of the engine. Data from the in-cylinder pressure sensor (i.e. transducer) were captured on a cycle-by-cycle basis for all transient tests. For the steady-state tests, 50 engine cycles were recorded and averaged to give a picture of the pressure, needle lift and calculated heat release during the combustion process. Ignition delay was calculated as the crank angle between the start of injection and the point at which the heat release passes from negative (i.e. fuel evaporation) to positive (i.e. combustion starting).

### Measurement of Acceleration

Speed calculations were made using a 60-tooth wheel and a magnetic speed pick-up. A computer converted a frequency signal generated by this equipment to rev/min.

A signal from the in-cylinder pressure transducer was measured with HSDA (High Speed Data Acquisition Apparatus) to calculate IMEP.

The responsiveness of the engine to the different fuels/fuel blends was tested in full throttle accelerations. The engine load was held close to 95% of maximum to extend the duration of the acceleration, as this exaggerated the effect of small differences.

40 full throttle accelerations were conducted on each fuel/fuel blend, divided into two sets of 20 so that the engine temperature did not rise excessively between each set. The engine was stabilized at 1350 rev/min before the throttle was snapped open. The time elapsed from the time the throttle was pressed to the time that the engine passed through six speed “gates” (i.e. 1500, 1700, 2000, 2500, 3000 and 3800 rev/min) was averaged for each set of 20 accelerations and the results are shown in Table 4 and FIG. 1.

TABLE 4

| | Acceleration time from 1350 r/min (seconds) | | | | | |
|---|---|---|---|---|---|---|
| Fuel | 1500 | 1700 | 2000 | 2500 | 3000 | 3800 |
| code | r/min | r/min | r/min | r/min | r/min | r/min |
| F2 | 2.43 | 3.27 | 4.03 | 4.63 | 5.03 | 5.77 |
| F2 | 2.83 | 3.82 | 4.63 | 5.25 | 5.66 | 6.43 |
| F1 | 2.40 | 3.14 | 3.83 | 4.41 | 4.78 | 5.46 |
| B1 | 2.24 | 2.98 | 3.68 | 4.27 | 4.64 | 5.33 |
| B2 | 2.36 | 3.16 | 3.87 | 4.45 | 4.83 | 5.54 |
| B3 | 2.63 | 3.47 | 4.21 | 4.79 | 5.18 | 5.93 |
| F2 | 2.25 | 3.09 | 3.86 | 4.46 | 4.86 | 5.62 |
| F2 | 2.55 | 3.43 | 4.18 | 4.78 | 5.18 | 5.96 |
| B3 | 2.32 | 3.13 | 3.88 | 4.47 | 4.87 | 5.61 |
| B2 | 2.28 | 3.07 | 3.77 | 4.35 | 4.74 | 5.45 |
| B1 | 2.08 | 2.81 | 3.50 | 4.08 | 4.46 | 5.16 |
| F1 | 2.24 | 2.95 | 3.65 | 4.23 | 4.60 | 5.27 |
| F2 | 2.50 | 3.35 | 4.09 | 4.68 | 5.07 | 5.84 |
| F2 | 2.28 | 3.13 | 3.88 | 4.47 | 4.88 | 5.71 |

Fuel averages

| | | | | | | |
|---|---|---|---|---|---|---|
| F1 | 2.32 | 3.05 | 3.74 | 4.32 | 4.69 | 5.37 |
| F2 | 2.47 | 3.35 | 4.11 | 4.71 | 5.11 | 5.89 |
| B1 | 2.16 | 2.90 | 3.59 | 4.18 | 4.55 | 5.24 |
| B2 | 2.32 | 3.11 | 3.82 | 4.40 | 4.78 | 5.49 |
| B3 | 2.47 | 3.30 | 4.05 | 4.63 | 5.02 | 5.77 |

Differences relative to F1 (−ve = slower)

| | | | | | | |
|---|---|---|---|---|---|---|
| F2 | −6.7% | −9.9% | −9.9% | −9.1% | −9.0% | −9.7% |
| B1 | 6.8% | 5.0% | 3.9% | 3.3% | 2.9% | 2.3% |
| B2 | −0.2% | −2.2% | −2.1% | −1.9% | −1.9% | −2.4% |
| B3 | −6.7% | −8.3% | −8.2% | −7.2% | −7.1% | −7.5% |

Differences relative to F2 (−ve = slower)

| | | | | | | |
|---|---|---|---|---|---|---|
| F1 | 6.3% | 9.0% | 9.0% | 8.3% | 8.2% | 8.9% |
| B1 | 12.7% | 13.5% | 12.6% | 11.4% | 10.9% | 10.9% |
| B2 | 6.1% | 7.0% | 7.1% | 6.6% | 6.5% | 6.7% |
| B3 | 0.0% | 1.5% | 1.6% | 1.7% | 1.7% | 2.0% |

It can be seen from FIG. 1 that, as expected, the low density diesel fuel F2 produces a lower acceleration than the high density diesel fuel F1. This is consistent with the well-known dependence of maximum torque and power on fuel density in volumetrically fuelled angines.

Surprisingly, however, when using blend B1 the engine accelerated much more quickly than when using fuels F1 and F2. It can be determined from the graph (by reference to the density) that blends of from 1 to 25% v/v Fischer-Tropsch fuel with fuel F1 would produce greater acceleration than fuel F1.

It can also be seen that the engine accelerated more quickly with blend B3 than with fuel F2, despite its low density.

### Example 2

This example illustrates the effects on the responsiveness of a second engine using Fischer-Tropsch derived diesel fuel, and by reference to acceleration time measured with a Renault Kangoo light van in chassis dynamometer tests.

### Test Fuels

The fuels used in the tests were a petroleum derived diesel fuel F4, and a blend B4 containing 85% by volume of said diesel fuel F4 and 15% Fischer-Tropsch (SMDS) derived diesel fuel (fuel F3 of Table 1).

The properties of fuel F4 and blend B4 are shown in Table 5:

TABLE 5

| | F4 | B4 |
|---|---|---|
| Density, kg/m³ | 830.0 | 823.5 |
| Sulfur content, mg/kg | 8 | 7 |
| Cetane number (BASF) | 58.7 | 58.8 |
| Initial boiling point, ° C. | 174.3 | 174.3 |
| T50, ° C. | 273.0 | nm |
| T95, ° C. | 346.5 | nm |
| Final boiling point, ° C. | 359.8 | 359.8 |
| Viscosity @ 40° C., mm²/s | 2.826 | 2.844 |

nm = not measured

### Test Vehicle

The test vehicle had the specification set out in Table 6:

TABLE 6

| | |
|---|---|
| Make | Renault |
| Model | Kangoo 1.5 cDi |
| Year | 2003 |
| Engine capacity | 1461 cm³ |
| Nominal power | 65 PS |
| Max. speed | 146 km/h |
| Weight | 1160 kg |
| Emissions category | Euro 3 |

The engine was fitted with a common rail fuel injection system. No modifications were made to the engine or fuel injection system for this test. The test vehicle was representative of standard production vehicles.

### Test Procedure

The vehicle was installed on a chassis dynamometer, using an inertia setting equivalent to the nominal weight of the vehicle plus driver, and rolling resistance and wind resistance settings calculated from the observed “coast-down” speed of the vehicle on level ground.

The vehicle was driven on the dynamometer until coolant and oil temperatures had stabilized.

Acceleration times were measured from 32-80 km/h (20-50 mph) in 3rd gear, from 48-96 km/h (30-60 mph) in 4th gear, and from 80-112 km/h (50-70 mph) in 5th gear.

The vehicle was driven at constant speed just below the starting speed in the chosen gear. The throttle pedal was fully depressed and the vehicle allowed to accelerate to just above the final speed in the chosen gear. Time (to the nearest 0.01 second) and speed were recorded by the chassis dynamometer data acquisition system, and the time taken to pass between the two speed “gates” was calculated.

Three accelerations were measured in each gear with each fuel tested and the average acceleration time was calculated.

### Results

The acceleration measurements are shown in Table 7, from which it can be seen that there was a consistent advantage for blend B4 compared to the base fuel F4, despite its lower density:

TABLE 7

| | Fuel | 3rd gear | 4th gear | 5th gear |
|---|---|---|---|---|
| | code | 32-80 km/h | 48-96 km/h | 80-112 km/h |
| Day 1 | F4 | 8.10 | 11.19 | 11.25 |
| | F4 | 8.06 | 11.11 | 11.15 |
| | B4 | 8.09 | 11.01 | 11.14 |
| | F4 | 8.09 | 11.11 | 11.07 |
| | B4 | 8.02 | 11.06 | 11.10 |
| | F4 | 8.06 | 11.03 | 11.06 |
| Day 2 | F4 | 8.08 | 11.05 | 11.10 |
| | B4 | 8.01 | 11.01 | 11.05 |
| | F4 | 8.10 | 11.06 | 11.24 |
| | F4 | 8.09 | 11.04 | 11.19 |
| | F4 | 8.10 | 11.09 | 11.15 |
| Averages | F4 | 8.08 | 11.08 | 11.15 |
| | B4 | 8.04 | 11.03 | 11.10 |
| | delta | −0.53% | −0.52% | −0.51% |

1-45. (canceled)

46. A method for increasing the rate of acceleration of a compression ignition engine, the method comprising:
providing a diesel fuel blend comprising (a) diesel fuel comprising petroleum derived gas oil, the diesel fuel boiling in the range of from 150 to 400° C. and exhibiting a first density at 15° C. of from 0.75 to 0.9 g/cm³, and (b) an amount of from about 1 to 25 vol. % of Fischer-Tropsch derived fuel exhibiting a second density at 15° C. of from 0.76 to 0.79 g/cm³, a majority of components of the Fischer-Tropsch derived fuel boiling at from 150 to 400° C., the amount of Fischer-Tropsch derived fuel being effective to produce the diesel fuel blend exhibiting a reduced density at 15° C. that is from about 0.08% to 1.92% less than the first density;
wherein, under given conditions, the compression ignition engine burning the diesel fuel accelerates from a speed of 1350 revolutions per minute (rpm) to a speed of 1500 rpm or more at a first acceleration time that is 0.3 second or more greater than a reduced acceleration time produced by the compression ignition engine burning the diesel fuel blend under the same conditions.

47. The method of claim 46 wherein the amount of Fischer-Tropsch derived fuel is effective to produce the diesel fuel blend exhibiting a reduced density at 15° C. that is from about 0.08% to 1.15% less than the first density.

48. The method of claim 46 wherein the amount of Fischer-Tropsch derived fuel is effective to produce the diesel fuel blend exhibiting a reduced density at 15° C. that is from about 0.38% to 1.15% less than the first density.

49. The method of claim 46 wherein the first acceleration time is 0.5 second or more greater than the reduced acceleration time.

50. The method of claim 46 wherein the first acceleration time is 1 second or more or more greater than the reduced acceleration time.

51. The method of claim 46 wherein the first acceleration time is 1.5 seconds or more or more greater than the reduced acceleration time.

52. The method of claim 46 wherein the first acceleration time is 2 seconds or more or more greater than the reduced acceleration time.

53. The method of claim 46 wherein the amount of Fischer-Tropsch derived fuel is from about 1 to about 15 vol. %.

54. The method of claim 46 wherein the diesel fuel blend comprises one or more additives selected from the group consisting of detergent-containing diesel fuel additives, lubricity enhancers, dehazers, anti-foaming agents, ignition improvers, anti-rust agents, corrosion inhibitors, reodorants, antiwear additives, antioxidants, metal deactivators, and combinations thereof.

55. A method for increasing the rate of acceleration of a turbocharged direct injection diesel engine, the method comprising:
providing a diesel fuel blend comprising (a) diesel fuel comprising petroleum derived gas oil, the diesel fuel boiling in the range of from 150 to 400° C. and exhibiting a first density at 15° C. of from 0.75 to 0.9 g/cm³, and (b) an amount of from about 1 to 25 vol. % of Fischer-Tropsch derived fuel exhibiting a second density at 15° C. of from 0.76 to 0.79 g/cm³, a majority of components of the Fischer-Tropsch derived fuel boiling at from 150 to 400° C., the amount of Fischer-Tropsch derived fuel being effective to produce the diesel fuel blend exhibiting a reduced density at 15° C. that is from about 0.08% to 1.92% less than the first density;
wherein, under given conditions, the turbocharged direct injection diesel engine burning the diesel fuel accelerates from a speed of 1350 revolutions per minute (rpm) to a speed of 1500 rpm or more at a first acceleration time that is 0.3 second or more greater than a reduced acceleration time produced by the turbocharged direct injection diesel engine burning the diesel fuel blend under the same conditions.

56. The method of claim 55 wherein the amount of Fischer-Tropsch derived fuel is effective to produce the diesel fuel blend exhibiting a reduced density at 15° C. that is from about 0.08% to 1.15% less than the first density.

57. The method of claim 55 wherein the amount of Fischer-Tropsch derived fuel is effective to produce the diesel fuel blend exhibiting a reduced density at 15° C. that is from about 0.38% to 1.15% less than the first density.

58. The method of claim 55 wherein the first acceleration time is 0.5 second or more greater than the reduced acceleration time.

59. The method of claim 55 wherein the first acceleration time is 1 second or more greater than the reduced acceleration time.

60. The method of claim 55 wherein the first acceleration time is 1.5 second or more greater than the reduced acceleration time.

61. The method of claim 55 wherein the first acceleration time is 2 second or more greater than the reduced acceleration time.

62. The method of claim 55 wherein the amount of Fischer-Tropsch derived fuel is from about 1 to about 15 vol. %.

63. A method for increasing the rate of acceleration of a compression ignition engine, the method comprising:
providing a diesel fuel blend comprising (a) diesel fuel comprising petroleum derived gas oil, the diesel fuel boiling in the range of from 150 to 400° C. and exhibiting a first density at 15° C. of from 0.75 to 0.9 g/cm³, and (b) an amount of from about 1 to 25 vol. % of Fischer-Tropsch derived fuel exhibiting a second density at 15° C. of from 0.76 to 0.79 g/cm³, a majority of components of the Fischer-Tropsch derived fuel boiling at from 150 to 400° C., the amount of Fischer-Tropsch derived fuel being effective to produce the diesel fuel blend exhibiting a reduced density at 15° C. that is from about 0.08% to 1.92% less than the first density;
wherein, under given conditions, the compression ignition engine burning the diesel fuel blend accelerates in third gear at a reduced acceleration time that less than an acceleration time produced by the compression ignition engine burning the diesel fuel blend under the same conditions.

64. The method of claim 63 wherein the amount of Fischer-Tropsch derived fuel is effective to produce the diesel fuel blend exhibiting a reduced density at 15° C. that is from about 0.08% to 1.15% less than the first density.

65. The method of claim 63 wherein the amount of Fischer-Tropsch derived fuel is effective to produce the diesel fuel blend exhibiting a reduced density at 15° C. that is from about 0.38% to 1.15% less than the first density.

66. The method of claim 63 wherein the reduced acceleration time is 0.3% or more less than the acceleration time.

67. The method of claim 63 wherein the reduced acceleration time is 0.5% or more less than the acceleration time.

68. The method of claim 63 wherein the reduced acceleration time is 0.53% or more less than the acceleration time.

69. The method of claim 63 wherein the reduced acceleration time is 1% or more less than the acceleration time.

70. A method for increasing the rate of acceleration of a turbocharged direct injection diesel engine, the method comprising:
providing a diesel fuel blend comprising (a) diesel fuel comprising petroleum derived gas oil, the diesel fuel boiling in the range of from 150 to 400° C. and exhibiting a first density at 15° C. of from 0.75 to 0.9 g/cm³, and (b) an amount of from about 1 to 25 vol. % of Fischer-Tropsch derived fuel exhibiting a second density at 15° C. of from 0.76 to 0.79 g/cm³, a majority of components of the Fischer-Tropsch derived fuel boiling at from 150 to 400° C., the amount of Fischer-Tropsch derived fuel being effective to produce the diesel fuel blend exhibiting a reduced density at 15° C. that is from about 0.08% to 1.92% less than the first density;
wherein, under given conditions, the turbocharged direct injection diesel engine burning the diesel fuel accelerates in third gear at a reduced acceleration time that is less than an acceleration time produced by the turbocharged direct injection diesel engine burning the diesel fuel blend under the same conditions.

71. The method of claim 70 wherein the amount of Fischer-Tropsch derived fuel is effective to produce the diesel fuel blend exhibiting a reduced density at 15° C. that is from about 0.08% to 1.15% less than the first density.

72. The method of claim 70 wherein the amount of Fischer-Tropsch derived fuel is effective to produce the diesel fuel blend exhibiting a reduced density at 15° C. that is from about 0.38% to 1.15% less than the first density.

73. The method of claim 70 wherein the first acceleration time is 0.3% or more less than the acceleration time.

74. The method of claim 70 wherein the first acceleration time is 0.53% or more less than the acceleration time.

75. The method of claim 70 wherein the first acceleration time is 0.75% or more less than the acceleration time.

76. The method of claim 70 wherein the first acceleration time is 1% or more less than the acceleration time.
